(19) United States
(12) Patent Application Publication
(10) Pub. No.: US 2022/0198381 A1
(43) Pub. Date: Jun. 23, 2022

(54) SECURITY SYSTEM

(71) Applicant: Nicholas Alan Waters, Derby (GB)

(72) Inventor: Nicholas Alan Waters, Derby (GB)

(21) Appl. No.: 17/604,727

(22) PCT Filed: Apr. 20, 2020
(86) PCT No.: PCT/GB2020/050980

§ 371 Date: Oct. 18, 2021

(30) Foreign Application Priority Data
Apr. 18, 2019 (GB) 1905588.8

(51) Int. Cl. G06Q 10/08

(52) U.S. Cl. CPC G06Q 10/0831; G06Q 10/0833; G06Q 10/0838

(57) ABSTRACT

A security system for monitoring cargo in motion during transport, comprising means for:
enabling generation of a log for the cargo, wherein the log defines one or more expected states of the cargo at one or more waypoints during transport, wherein an expected state is dependent upon at least a mass or volume of the cargo;
enabling storage of the log as part of a distributed ledger;
enabling a comparison of a measured state of the cargo at a waypoint, while in motion, and an expected state of the cargo at the waypoint, wherein the measured state of the cargo at the waypoint is dependent upon at least a measured mass or volume of the cargo, wherein the expected state of the cargo at the waypoint is determined by accessing the log within the distributed ledger;
generating a security alert if a deviation is detected between the measured state of the cargo and the expected state of the cargo at the waypoint.

### FIELD OF THE INVENTION

Embodiments of the present invention relate to a security system. In particular, they relate to a security system that secures supply chains and enables automated free flow and/or borderless customs.

### BACKGROUND TO THE INVENTION

Increases in the volume and complexity of international trade and a growing pressure on supply chains has led to a call for a new approach for the management of cross border trade. There is also a need to mitigate security threats, tax evasion and organized crime.

Customs administrations play an integral role in international trade, undertaking the essential tasks of enforcing the law, collecting duties and taxes, providing prompt clearance of goods and ensuring compliance.

Customs administrations are now facing ever increasing, and at times contradictory demands arising from the globalization of trade. On the one hand, there is a need for effective security and control of international supply chains while on the other hand, there are increasing demands for greater facilitation of legitimate trade.

### BRIEF DESCRIPTION OF VARIOUS EMBODIMENTS OF THE INVENTION

According to various, but not necessarily all, embodiments of the invention there is provided a security system for monitoring cargo in motion during transport, comprising means for:
enabling generation of a log for the cargo, wherein the log defines one or more expected states of the cargo at one or more waypoints during transport, wherein an expected state is dependent upon at least a mass or volume of the cargo;
enabling storage of the log as part of a distributed ledger;
enabling a comparison of a measured state of the cargo at a waypoint, while in motion, and an expected state of the cargo at the waypoint, wherein the measured state of the cargo at the waypoint is dependent upon at least a measured mass or volume of the cargo, wherein the expected state of the cargo at the waypoint is determined by accessing the log within the distributed ledger;
generating a security alert if a deviation is detected between the measured state of the cargo and the expected state of the cargo at the waypoint.

In some but not necessarily all examples, the comparison of the measured state of the cargo at the waypoint and the expected state of the cargo at the waypoint is performed using machine-learning.

In some but not necessarily all examples, the comparison accounts for an effect of motion on measurement of the measured state of the cargo at a waypoint, while in motion.

In some but not necessarily all examples, the comparison accounts for an effect of fuel consumption on the measured state of the cargo at a waypoint, while in motion.

In some but not necessarily all examples, the comparison comprises

forming a collective measured state of the cargo at the waypoint from multiple measured states at multiple waypoints while in motion including the measured state of the cargo at the waypoint, while in motion,
enabling a comparison of the collective measured state of the cargo at the waypoint and the expected state of the cargo at the waypoint,

In some but not necessarily all examples, the collective measured state is formed from multiple measured states at multiple waypoints by one or more of the following singly or in combination:

competitive selection of measured states;

complementary addition of measured states; and

cooperative combination of measured states.

In some but not necessarily all examples, the collective measured state is formed from multiple measured states by averaging all or a sub-set of the measured states

In some but not necessarily all examples, the log for the cargo is generated in response to input information from an importer of the cargo and/or an exporter of the cargo.

In some but not necessarily all examples, the input information comprises a digital signature of the importer and a digital signature of the exporter.

In some but not necessarily all examples, the digital signature is created using public/private key encryption.

In some but not necessarily all examples, the log comprises properties of the cargo including the mass and/or volume of the cargo and information relating to transport of the cargo including expected itinerary.

In some but not necessarily all examples, the security system comprises means for causing the log within the distributed ledger to be updated with at least an entry comprising the measured state of the cargo at the waypoint, while in motion.

In some but not necessarily all examples, each of the multiple expected states of the cargo defines properties of the cargo including the mass and/or volume of the cargo that are expected at a given stage during transport.

In some but not necessarily all examples, storing the log as part of a distributed ledger comprises storing the log as data within a block of a blockchain.

In some but not necessarily all examples, storing the log as part of a distributed ledger comprises storing the log as data within a blockless distributed ledger.

In some but not necessarily all examples, the security system comprises means for receiving at least one measured state of the cargo, at the waypoint, while in motion during transport, the measured state comprising at least one or more sensed properties of the cargo in addition to mass or volume of the cargo.

In some but not necessarily all examples, the security system comprises means for receiving a detected unique identifier associated with the cargo that has been detected at the waypoint while in motion during transport of the cargo, using the received unique identifier to enable identification of the log for the cargo within the distributed ledger, wherein the identification of the log within the distributed ledger enables the comparison of the measured state of the cargo at the waypoint and the expected state of the cargo at the waypoint.

In some but not necessarily all examples, the unique identifier associated with the cargo comprises one or more of: a unique identifier of a vehicle transporting the cargo, a unique identifier of a driver of a vehicle transporting the cargo, and a unique identifier of the cargo.

In some but not necessarily all examples, generating a security alert comprises sending a signed data structure via a telecommunications network to a remote customs monitoring station.

In some but not necessarily all examples, the security system comprises means for enabling generation of a log for the cargo, wherein the log defines one or more expected states of the cargo at one or more waypoints during transport, wherein an expected state is dependent upon at least a mass of the cargo and/or a volume of the cargo.

In some but not necessarily all examples, a system comprises the security system and a distributed network of sensors configured to measure states of the cargo at waypoints, while in motion.

In some but not necessarily all examples, a borderless customs arrangement comprising the system. In some but not necessarily all examples, the sensors are not located at the border.

According to various, but not necessarily all, embodiments of the invention there is provided a method of performing custom checks on vehicles during transport, comprising
enabling generation of a log for the cargo, wherein the log defines one or more expected states of the cargo at one or more waypoints during transport, wherein an expected state is dependent upon at least a mass or volume of the cargo;
enabling storage of the log as part of a distributed ledger;
enabling a comparison of a measured state of the cargo at a waypoint, while in motion, and an expected state of the cargo at the waypoint, wherein the measured state of the cargo at the waypoint dependent upon at least a measured mass or volume of the cargo, wherein the expected state of the cargo at the waypoint is determined by accessing the log within the distributed ledger;
generating a customs security alert if a deviation is detected between the measured state of the cargo and the expected state of the cargo at the waypoint.

According to various, but not necessarily all, embodiments of the invention there is provided a security system for monitoring cargo during transport, comprising means for:
enabling generation of a log for the cargo, wherein the log defines one or more expected states of the cargo at one or more waypoints during transport;
enabling storage of the log as part of a distributed ledger;
enabling a comparison of a measured state of the cargo at a waypoint and an expected state of the cargo at the waypoint,

wherein logic for enabling the comparison is determined by accessing the log within the distributed ledger;

wherein the expected state of the cargo at the waypoint is determined by accessing the log within the distributed ledger; and
generating a security alert if a deviation is detected between the measured state of the cargo and the expected state of the cargo at the waypoint.

In some but not necessarily all examples, logic for enabling generation of the security alert is determined by accessing the log within the distributed ledger.

In some but not necessarily all examples, the logic for enabling the comparison defines logic of a state machine;

wherein a current state of the state machine is determined by accessing the log within the distributed ledger;

wherein the measured state of the cargo at the waypoint and the expected state of the cargo at the waypoint are inputs to the state machine;

causing the log within the distributed ledger to be updated with a post-input state of the state machine;

causing generating a security alert in dependence upon the post-input state of the state machine.

According to various, but not necessarily all, embodiments of the invention there is provided a security system for monitoring cargo in motion during transport, comprising means for:
enabling generation of a log for the cargo, wherein the log defines one or more expected states of the cargo at one or more waypoints during transport, wherein an expected state is dependent upon at least an externally measurable physical parameter of the cargo;
enabling storage of the log as part of a distributed ledger;
enabling a comparison of a measured state of the cargo at a waypoint, while in motion, and an expected state of the cargo at the waypoint, wherein the measured state of the cargo at the waypoint is dependent upon at least an externally measured physical parameter of the cargo, wherein the expected state of the cargo at the waypoint is determined by accessing the log within the distributed ledger;
generating a security alert if a deviation is detected between the measured state of the cargo and the expected state of the cargo at the waypoint.

An externally measurable physical parameter of the cargo can for example be mass or volume (or a parameter dependent upon volume such as density or a dimension such as height, length, width) or a parameter representing one or more features of an x-ray image or other remote external physical sensing of the cargo.

According to various, but not necessarily all, embodiments of the invention there is provided system as described in the appended claims.

At least some embodiments, enable cargo to undergo verifiable non-intrusive checks whilst in motion. This creates a step change in the efficiencies of trade and logistics.

At least some embodiments, enable cargo to be checked many times along a supply route. This enables borderless customs, that is, customs not necessarily at border.

At least some embodiments, enable a technological solution to a political problem. Post-Brexit (after the UK leaves the EU) it will be necessary to monitor the EU-UK border within the island of Ireland, without re-introducing a hard border, with custom stations, between Northern Ireland and Southern Ireland. There has not, until now, been a technical solution to this problem. The monitoring station used by the system can be place along road networks within Northern Ireland, rather than at the border.

### BRIEF DESCRIPTION OF THE DRAWINGS

For a better understanding of various examples of embodiments of the present invention reference will now be made by way of example only to the accompanying drawings in which:

FIG. 1 illustrates an example of a system suitable for a borderless customs arrangement comprising s security system;

FIG. 2 illustrates an example of a security system;

FIG. 3 illustrates another example of a security system;

FIG. 4 illustrates an example of a method;

FIG. 5A illustrates an example of a controller for the security system; and

FIG. 5B illustrates an example of a computer program for the security system.

### DETAILED DESCRIPTION OF VARIOUS EMBODIMENTS OF THE INVENTION

The Figures illustrate a security system 100 for monitoring cargo 10 during transport 60, comprising means 110, 120, 130, 140 for:
enabling generation of a log 112 for the cargo 10, wherein the log 112 defines one or more expected states 114 of the cargo 10 at one or more waypoints 30 during transport 60;
enabling storage of the log 112 as part of a distributed ledger 200;
enabling a comparison of a measured state of the cargo 10 at a waypoint 30 and an expected state 152 of the cargo 10 at the waypoint 30, wherein the expected state 152 of the cargo 10 at the waypoint 30 is determined by accessing the log 112 within the distributed ledger 200;
generating a security alert 142 if a deviation is detected between the measured state of the cargo 10 and the expected state 152 of the cargo 10 at the waypoint 30.

In the following detailed description, reference will be made to the following terms:

A distributed ledger: a distributed ledger (or distributed digital ledger) is a distributed consensus of replicated, shared, and synchronized digital data geographically spread across multiple nodes, for example, sites, countries, or institutions. There is no central administrator or centralized data storage.

The distributed ledger database is spread across several nodes on a peer-to-peer network, where each node replicates and saves an identical copy of the ledger and updates itself independently.

When a ledger update happens, each node constructs the new transaction, and then the nodes vote by consensus algorithm on which copy is correct. Once a consensus has been determined, all the other nodes update themselves with the new, correct copy of the ledger. Security is accomplished through cryptographic keys and signatures.

The distributed ledger is immutable because it cannot be altered retroactively without consensus.

Blockchain: A blockchain is a type of distributed ledger that takes a number of records and puts them in a block. Each block is then ‘chained’ to the next block, using a cryptographic hash. This allows blockchains to be used like an incorruptible ledger, which can be shared and corroborated by anyone with the appropriate permissions. There are many ways to corroborate the accuracy of a ledger, but they are broadly known as consensus. If participants in that process are preselected, the ledger 200 is permissioned. If the process is open to everyone, the ledger 200 is unpermissioned. Blocks of the blockchain are sealed in a ‘mining’ process with a designed high cost.

A cryptographic hash function is a one-way function that maps data of arbitrary size to a bit string of fixed size (a hash value).

The blockchain is a timestamped incorruptible series (chain) of immutable data records (blocks) that is managed by a cluster of computers not owned by a single entity.

Digital signature: Digital signing encodes information using a cipher in such a way that the receiver can verify the identity of the sender (authentication) and verify that the information has not been altered in transit (integrity). In a symmetric-key scheme the encryption and decryption keys are the same and it is suitable for communicating between secured environments. In an asymmetric-key scheme the encryption and decryption keys are different. For example, in public key cryptography, a private key of the sender is used to encrypt data (or a hash of the data) and a public key of the sender is used to decrypt the data (or the hash of the data). The public key can only properly decrypt data that has been encrypted by the private key. Therefore, successful decryption verifies that the data (or hash of the data) was originally signed using the private key of the sender. A timestamp (and date) may be automatically added to the data before it is encrypted.

Encryption: Encryption encodes information using a cipher in such a way that only authorized parties can access it and those who are not authorized cannot. In a symmetric-key scheme the encryption and decryption keys are the same and is suitable for communicating between secured environments. In an asymmetric-key scheme the encryption and decryption keys are different. For example, in public key cryptography a public key of an intended recipient is used to encrypt data and a private key of the recipient is used to decrypt the data. The encrypted data can only properly be decrypted using the correct private key of the receiver.

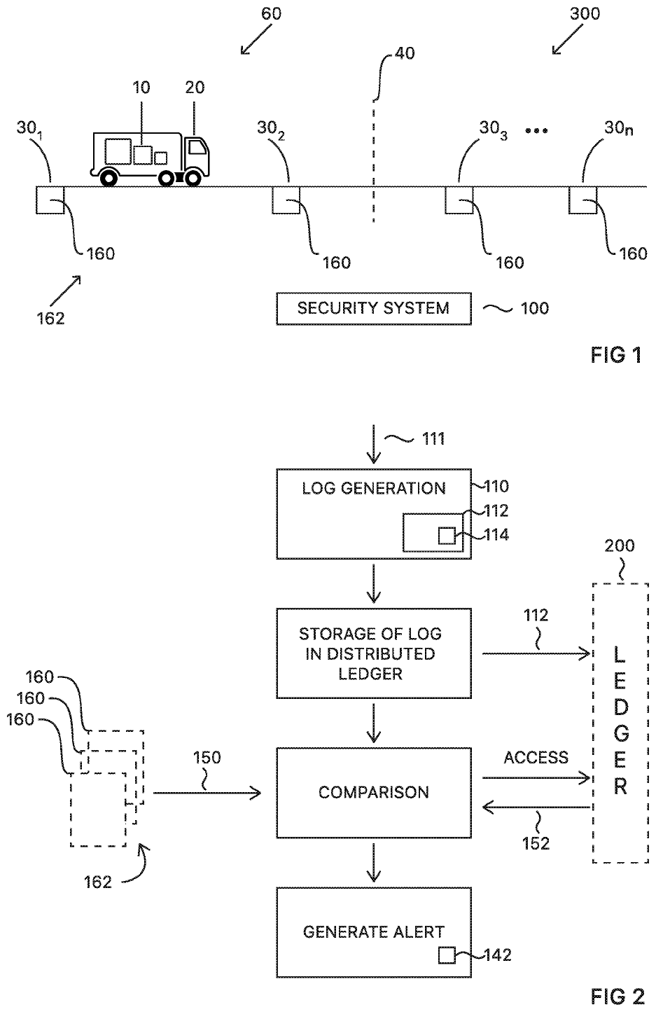

In FIG. 1, a vehicle 20 transports 60 a cargo 10. The vehicle 20 (and cargo 10) are in motion along a route comprising a plurality of waypoints 30. The route starts at an initial waypoint 30₁ and ends at a final waypoint 30ₙ and passes through one or more intermediate waypoints 30ᵢ. The initial waypoint 30₁ can be at a start of a journey of on-route during the journey.

Some or all of the waypoints 30 have monitoring stations and each monitoring station has one or more sensors 160. The distributed monitoring stations form a distributed network 162 of sensors 160.

The sensors 160 are part of a security and monitoring system 300 comprising a security system 100 and the distributed network 162 of sensors 160.

The security system 100 is configured to monitor the cargo 10 during transport 60 and, as illustrated in FIG. 2, comprises:
means 110 for enabling generation of a log 112 for the cargo 10, wherein the log 112 defines one or more expected state 152s 152 114 of the cargo 10 at one or more waypoints 30 during transport 60;
means 120 for enabling storage of the log 112 as part of a distributed ledger 200;
means 130 for enabling a comparison of a measured state of the cargo 10 at a waypoint 30 and an expected state 152 of the cargo 10 at the waypoint 30, wherein the expected state 152 of the cargo 10 at the waypoint 30 is determined by accessing the log 112 within the distributed ledger 200; and
means 140 for generating a security alert 142 if a deviation is detected between the measured state of the cargo 10 and the expected state 152 of the cargo 10 at the waypoint 30.

The system 300 is a de-centralised/distributed system which accurately and efficiently records, shares and verifies supply chain data of cargo 10 while in transit. This is particularly useful for international supply chains across borders 40.

In some but not necessarily all examples, some of the sensors 160 are configured to measure states of cargo 10 at waypoints 30, while the cargo 10 is stationary.

At least some of the sensors 160 are configured to measure states of cargo 10 at waypoints 30, while the cargo 10 is in motion. In motion in this sense means that the cargo 10 has a velocity relative to the sensors 160.

The security system 100 is then configured to monitor cargo 10 in motion during transport, and comprises:
means 110 for enabling generation of a log 112 for the cargo 10, wherein the log 112 defines one or more expected state 152s 152 114 of the cargo 10 at one or more waypoints 30 during transport 60, wherein an expected state 152 114 is dependent upon at least a mass of the cargo 10;
means 120 for enabling storage of the log 112 as part of a distributed ledger 200;
means 130 for enabling a comparison of a measured state of the cargo 10 at a waypoint 30, while in motion, and an expected state 152 of the cargo 10 at the waypoint 30, wherein the measured state of the cargo 10 at the waypoint 30 is dependent upon at least a measured mass and/or volume of the cargo 10, wherein the expected state 152 of the cargo 10 at the waypoint 30 is determined by accessing the log 112 within the distributed ledger 200; and
means 140 for generating a security alert 142 if a deviation is detected between the measured state of the cargo 10 and the expected state 152 of the cargo 10 at the waypoint 30.

The system 300 enables cargo 10 to undergo verifiable, non-intrusive checks whilst in motion.

The system 300 requires little or no border infrastructure. The sensors 160 can be positioned at strategic points to ensure full coverage of the supply chain network, for example covering routes to or from the border 40. Remote customs monitoring stations are alerted by the security system 100 if there is a detected discrepancy. This can for example flag the cargo 100 as an exception that will require intervention.

In some examples, customs outposts can be located at a distance from ports to relieve traffic flow pressure.

In the example illustrated in FIG. 1, the system 300 is for a borderless customs arrangement. The system 300 is configured to automate conventional customs checks such as for example the determination and collection of duties and taxes and the checking of legal compliance. In the example illustrated, the sensors 160 are not located at the border 40 but are, instead located at routes that lead to or from the border 40.

The system 300 allows cargo 10 to be checked many times along the supply route. This enables borderless customs, that is, customs not necessarily at an international border 40.

It should be noted that the expected state 152 of the cargo 10 at the waypoint 30 provided from the ledger 200 to the security system 100 can be but is not necessarily the same as an expected state 152 114 of the cargo 10 previously provided by the security system 10 to the ledger 200. The expected state 152 of the cargo 10 provided to the system 100 can for example be interpolated from expected states 114 of the cargo 10 provided by the system 100. For example, if the log 112 for the cargo 10 defines that the expected state 152 of the cargo 10 is a first state S₁ at the initial waypoint 30₁ and defines that there are no cargo 10 drop-offs or changes to the cargo 10 along the route or that the state of the cargo 10 at the end waypoint 30ₙ is the state S₁, then it can be inferred that the state of the cargo 10 at each of the intermediate waypoints 30ᵢ should be the first state S₁.

The sensors 160 that provide measurements that are used to define the measured state of the cargo 10 at a waypoint 30, for example, while in motion, are or can be separate from the security system 100. The sensors 160 can communicate measurements to the security system 100 using any suitable communications channel.

The distributed ledger 200 is not part of the security system 200. In some but not all examples, the storing of the log 112 as part of a distributed ledger 200 comprises storing the log 112 as data within a block of a blockchain. In some other examples, the storing of the log 112 as part of a distributed ledger 200 comprises storing the log 112 as data within a blockless distributed ledger 200.

In some, but not necessarily all examples, the log 112 for the cargo 10 is generated in response to input information 111 from an importer of the cargo 10 and/or an exporter of the cargo 10 and/or a logistics company. The input information 111 from the exporter can for example, comprise a digital signature of the exporter. The input information 111 from the importer can for example, comprise a digital signature of the importer. The input information 111 from the logistics/delivery company can for example, comprise a digital signature of the company. As described previously the digital signature can be created using asymmetric encryption.

In some but not necessarily all examples, the log 112 for the cargo 10 comprises properties of the cargo 10 including the mass of the cargo 10 and information relating to transport of the cargo 10 including expected itinerary.

At least some of the properties are verifiable by remote sensing of the cargo 10 using at least some of the sensors 160.

The sensors 160 at the waypoints 30 are configured to sense one or more properties of the cargo 10. For example a waypoint monitoring station can comprise one or more of:

a mass (weight) in motion sensor that measure mass of a moving vehicle 20;

a radio frequency identification (RFID) reader;

a radio frequency transceiver, for example a 5G transceiver, configured to form an internet of things (IoT) or other communication link or network with transceivers in the vehicle 20 or on or in the cargo 10;

a sensor for remotely interrogating a smart lock of the vehicle to obtain a history of openings and closing of a door to a cargo hold of the vehicle 20;

a x-ray fluorescence (XRF) sensor for detecting emission of characteristic radiation from a material that has been excited by bombarding with high-energy X-rays or gamma rays; and

a x-ray sensor for capturing an x-ray image of the vehicle 20 and cargo 10. This can be a high speed, low dose x-ray;

a GPS sensor for capturing historic GPS data from the vehicle 20;

a sensor for remotely interrogating (directly or indirectly) a smart container transported by the vehicle 20 to obtain a history of sensor readings from within the container and/or real-time sensor readings within the container. The in-container sensors can include any suitable sensor including but not limited to motion sensors and/or IR cameras for producing heat maps, capture and tracking devices for serial numbers, 1D/2D bar codes, RFID, NFC etc, location, GPS positioning, vibration, ultrasound, temperature, light, humidity, atmospheric sensors, volumetric capture and depth scanning. A mediated reality headset may be used to move within a virtual representation of the space within the cargo hold. Mediated reality can be virtual reality, augmented reality or mixed reality, 3DoF, 3DoF+, 6DoF;

a camera sensor for capturing a visual image of the vehicle for image processing. This can, for example, detect vehicle size, shape, number of axles and recognise hazardous cargo labels;

an automatic number plate recognition camera for recognising a number plate of the vehicle;

a lidar sensor for measuring dimensions of the vehicle;

Other sensors 160 are possible such as drone, satellite for visual/radio/GPS . . . monitoring, tracking and communication.

While the sensors 160 have been described as being at the waypoints, it should be appreciated that none, some or all of the sensors 160 could be within a smart container that communicates measurements made at the waypoints (e.g. a point of entry, at set time periods, at set locations, when requested or constantly) A smart container is a physical logistics unit (ie, Shipping Container, Trailer, Cargo hold etc.) that utilises inbuilt sensors to monitor and transmit data about contents, location, environment and other factors.

When the cargo 10 enters the container it can, in some examples, be sensed by a sensor and the addition of the cargo can be registered to the log 112 in the distributed ledger 200. When the cargo 10 leaves the container it can, in these examples or other examples, be sensed by a sensor and the removal of the cargo can be registered to the log 112 in the distributed ledger 200. The sensor 160 can be positioned on existing infrastructure such as bridges and gantries. In some but not necessarily all examples, a sensor (or sensors) 160 may be mobile and positioned within a vehicle or mounted on a drone or satellite.

In some but not necessarily all examples, the sensors 160 include one or more of:

modal analysis (vibration testing);

terahertz imaging systems;

near-infrared imaging (NIR)systems;

photogrammetric measuring systems;

fluorescence, luminescence, and reflection-based detection systems;

wavefront sensors;

femtosecond laser system;

mems microsensors;

infrared bolometer detectors;

hyperspectral imaging sensors;

multispectral imaging sensors;

spectral analysis;

mass analysers (mass spectrometry);

synthetic aperture radar (SAR);

synthetic aperture ladar (SAL);

x-ray computed tomography (CT) scanners;

load cell (electronic weighing instruments);

complete weighing instruments;

quantum sensors;

scanning laser vibrometer;

3d scanning vibrometer;

laser trackers;

mobile metering;

optical comparator;

mobile weighing scales/weigh bar weight sensors (built into container or vehicle);

weighbridges/axle weighing/weigh pads;

load cells, multiple cells can be used in various configurations;

vibration (accelerometer) sensors;

ultrasound sensors;

temperature sensors;

light sensors;

humidity sensors;

atmospheric sensors;

Adaptive optics

Random light or Scattered light and speckle correlation imaging.

Optical focusing with time-reversed ultrasonically encoded (TRUE) light

Multi-photon intrapulse interference phase scanning

“time-of-flight” imaging

Optical phase conjugation

Digital holography

Structured Light technology

tactile sensors

Computational Imaging

Tomographic imaging

Shape Analysis

Odometry

SLAM (Simultaneous localization and mapping)

OpenCV (Open source computer vision)

3D Scanning

Systems such as Realsence or ARcore that use Motion tracking, Environmental understanding, Light estimation

Depth cameras

photogrammetry

Environmental parameters e.g. Temperature, rain, wind etc. can affect measurements and may need to be accounted for.

The security system 100 is configured to receive the measured state of the cargo 10 at a waypoint 30 from the sensors 160 at the waypoint 30.

In at least some examples, the security system 100 is configured to cause the log 112 within the distributed ledger 200 to be updated with at least an entry comprising the measured state 150 of the cargo 10 at the waypoint, for example, while in motion.

The measured state 150 comprises at least one or more sensed properties of the cargo 10. It can, for example, include:

mass of the cargo 10;

information relating to access to cargo 10 hold e.g. door openings

information relating to sensing of cargo 10 hold e.g. motion detection, threshold crossing, door opening.

The security system 100 is configured to receive a detected unique identifier associated with the cargo 10 that has been detected at the waypoint 30 while in motion during transport of the cargo 10, for example from a sensor 160.

The security system 100 is configured to use the received unique identifier to enable identification of the log 112 for the cargo 10 within the distributed ledger 200, access the identified log 112 and receive the expected state 152 of the cargo 10 at the waypoint 30. This enables comparison of the measured state of the cargo 10 at the waypoint 30 and the expected state 152 of the cargo 10 at the waypoint 30.

In some but not necessarily all examples the unique identifier associated with the cargo 10 comprises one or more of: a unique identifier of the vehicle 20 transporting the cargo 10, a unique identifier of a driver of a vehicle 20 transporting the cargo 10, and a unique identifier of the cargo 10.

When used in “groupage” or mixed cargo (more than 1 party's items are included in the cargo) identifiers can be associated, under a prime indicator. Groupage is a method of logistics in which goods are transported in a cargo 10 with other goods, where the cargo is in a container it can be referred to as LCL (Less than Container Load). Multiple LCL cargos with different owners can be loaded in a single container. The system can batch or combine the Groupage or LCL cargos under a single unique identifier

The unique identifier can be obtained via remote sensing using a sensor 160.

A driver can be identified by capturing an image of the driver in the vehicle 20 using a camera and using facial recognition processing on the captured image or other biometric reading. More than one person (driver/passenger) can be registered to the vehicle. If the driver, passenger or number of persons change this is signed by an authority and recorded on the distributed ledger 200.

A driver can be identified by interrogating a radio-frequency tachometer driver card using a radio frequency signal. The tachometer driver card could for example comprise a radio frequency identification (RFID) chip.

A driver can be identified by interrogating a radio-frequency government document (e.g. a passport, driving licence, identity card . . . ) using a radio frequency signal. The tachometer driver card could for example comprise a radio frequency identification (RFID) chip.

A vehicle 20 can be identified by capturing an image of the vehicle 20 using a camera and using automatic number plate recognition (ANPR) processing on the captured image.

A vehicle 20 can be identified by capturing a series of images of the vehicle 20 using a camera and using computer vision processing on the captured images to isolate the object moving within the sequence of images and to creature a unique feature map for visual attributes of the moving object.

Cargo 10 can be identified by interrogating a radio frequency identification (RFID) chip or chips within or attached to the cargo 10 using a radio frequency signal.

Cargo 10 can be identified by requesting a real-time captured image from one or more on-board vehicle cameras using a radio frequency signal. Computer vision processing of the captured image can be used to isolate bar codes or quick response (QR) codes on the cargo 10 or creature a unique feature map for visual attributes of the cargo 10.

The security system 100 is configured to compare the received measured state of the cargo 10 at the waypoint 30, for example, while in motion, and the received expected state 152 of the cargo 10 at the waypoint 30

The expected state 152 of the cargo 10 at the waypoint 30 is determined by accessing the log 112 within the distributed ledger 200. The log 112 can record expected states 152 of the cargo 10 for different waypoints 30. Each of the multiple expected states 152 of the cargo 10 defines properties of the cargo 10, for example, including the mass of the cargo 10 that are expected at a given stage or waypoint 30 during transport.

In some but not necessarily all examples, the comparison of the measured state 150 of the cargo 10 at the waypoint 30 and the expected state 152 of the cargo 10 at the waypoint 30 is performed using machine-learning. For example supervised or reinforcement learning may be used for (dis)similarity detection between the measured state and the expected state 152. For example, unsupervised anomaly detection can be used to detect the measured state 150 as an unusual anomalous event compared to previously measured states. An unusual anomalous event can, in some but not necessarily all examples, be categorized as: global anomalies, contextual (or conditional) anomalies, and collective anomalies.

For example, a support vector machine can be used as a binary classifier classifying the measured state 150 as expected or anomalous. For example, a Bayesian network can be optimised for decision making concerning whether the measured state 150 is as expected or anomalous.

In some but not necessarily all examples, the comparison of the measured state 150 of the cargo 10 at the waypoint 30 and the expected state 152 of the cargo 10 at the waypoint 30 is performed using a cost function, that takes as input parameters the measured state 150 of the cargo 10 at the waypoint 30 and the expected state 152 of the cargo 10 at the waypoint 30.

In some but not necessarily all examples, the comparison of the measured state 150 state 152 of the cargo 10 a the waypoint 30.

In some but not necessarily all examples, the measured state 150 is scored and the appropriate action is carried out. The amount, type and severity of discrepancies can dictate the action required: clear to go, monitor, or immediate intervention.

In some but not necessarily all examples, the comparison accounts for an effect of motion on measurement of the measured state 150 of the cargo 10 at a waypoint, while in motion. This can for example be achieved implicitly via machine learning or explicitly by defining acceptable tolerances of measurements before a change in measurement is determined.

In some but not necessarily all examples, an uncertainty value is used to express a margin of doubt about the measurement. Uncertainty is different to an error. Uncertainty is a quantification of the doubt about the measurement result. An error is the difference between the measured value and the ‘true value’ of the thing being measured. Uncertainty values are important in determining a tolerance.

In some but not necessarily all examples, the comparison accounts for an effect of fuel consumption on the measured state 150 of the cargo 10 at a waypoint, while in motion. For example, as fuel is consumed the measured mass of the vehicle plus cargo 10 decreases while the mass of the cargo 10 remains constant. Therefore to accurately detect a change in mass of the cargo 10, the change in mass of the vehicle, as a consequence of fuel consumption, is estimated. Fuel consumption can be estimated knowing the identity of the vehicle, the mass of the cargo 10 and the average speed of the vehicle. The identity of the vehicle 20 and the mass of the cargo 10 can be obtained from the log 112. The timestamps of when the vehicle passed through particular waypoints can be obtained from the log 112 and used to estimate the average speed of the vehicle 20.

In some but not necessarily all examples, the logic for enabling the comparison is on the distributed ledger 200 and is determined by accessing the log 112 within the distributed ledger 200.

In some but not necessarily all examples, the logic for enabling generation of the security alert is on the distributed ledger 200 and is determined by accessing the log 112 within the distributed ledger 200.

In one example, the logic for enabling the comparison defines logic of a state machine. A current state of the state machine is on the distributed ledger 200 and is determined by accessing the log 112 within the distributed ledger 200.

The measured state 150 of the cargo 10 at the waypoint 30 (from the sensors 160) and the expected state 152 of the cargo 10 at the waypoint 30 (from accessing the log 112 within the distributed ledger 200) are inputs to the state machine.

If a deviation is not detected between the measured state of the cargo 10 and the expected state 152 of the cargo 10 at the waypoint 30 then the log 112 within the distributed ledger 200 112 is updated with a new, post-input state of the state machine.

If a deviation is detected between the measured state of the cargo 10 and the expected state 152 of the cargo 10 at the waypoint 30 then a security alert is generated.

If a new post-input state of the state machine is be created, the log 112 within the distributed ledger 200 112 is updated with a new, post-input state of the state machine.

In some but not necessarily all examples, the logic is fuzzy logic, and the state machine is a fuzzy state machine.

In some but not necessarily all examples, it is desirable to pre-process the measured state 150 of the cargo 10. In these examples, the comparison additionally comprises forming a collective measured state 150 of the cargo 10 at the waypoint 30 from multiple measured states 150 at multiple waypoints, while in motion, including the measured state 150 of the cargo 10 at the waypoint, while in motion, and then enabling a comparison of the collective measured state 150 of the cargo 10 at the waypoint 30 and the expected state 152 of the cargo 10 at the waypoint 30.

In some but not necessarily all examples, the collective measured state 150 is formed from multiple measured states 150 at multiple waypoints by one or more of the following singly or in combination:

(i) competitive selection of (alternative) measured states 150 e.g. A or B;

(ii) complementary addition of (non-overlapping portions of) measured states 150 e.g. A U B; and

(iii) cooperative combination of (overlapping) measured states 150 e.g. average A & B.

In some but not necessarily all examples, the collective measured state 150 is formed from multiple measured states 150 by averaging all or a sub-set of the measured states 150. The sub-set may exclude one or more outliers in the set, for example.

In some but not necessarily all examples, the collective measured state 150 is formed from multiple measured states 150 but weighs some measured states 150 more than others.

As an example, a driver action such as open a door to the cargo 10 or delivering cargo 10 can cause a change in a measured state 150. However, it is desirable to distinguish between an authorised change in the measured state 150 and an unauthorised change in the measure state. For example, if the driver checks the cargo 10 and opens the cargo door this can be detected by a sensor in the vehicle and reported to a sensor 160 at a waypoint. For example, if the delivers checks a part of the cargo 10 this can be detected as a change in mass by a sensor 160 at a waypoint. For example, if the driver changes route/itinerary this can be detected. In some but not necessarily all examples, the driver can verify an action that causes a change in the measured state 150 using his digital signature. The driver can verify the action (door opening/delivery/route change) by creating a digitally signed verification datum that is stored in the log 112 of the distributed ledger 200. In some but not necessarily all examples, the measured state 150 is weighed by the trust level of the verifier, in this case the driver.

The security system 100 is configured to generate a security alert 142 if a deviation is detected between the measured state of the cargo 10 and the expected state 152 of the cargo 10 at the waypoint 30.

In some but not necessarily all examples generating a security alert 142 comprises sending a signed data structure via a telecommunications network to a remote customs monitoring station. It may also comprise writing data to the log 112 of the distributed ledger 200.

It will be appreciated from the foregoing description, that the security system 100 for monitoring cargo 10 during transport, comprises in some examples means for:
enabling generation of a log 112 for the cargo 10, wherein the log 112 defines one or more expected state 152s 152 114 of the cargo 10 at one or more waypoints 30 during transport 60;
enabling storage of the log 112 as part of a distributed ledger 200;
enabling a comparison of a measured state of the cargo 10 at a waypoint 30 and an expected state 152 of the cargo 10 at the waypoint 30,

wherein logic for enabling the comparison is determined by accessing the log 112 within the distributed ledger 200;

wherein the expected state 152 of the cargo 10 at the waypoint 30 is determined by accessing the log 112 within the distributed ledger 200; and
generating a security alert if a deviation is detected between the measured state of the cargo 10 and the expected state 152 of the cargo 10 at the waypoint 30.

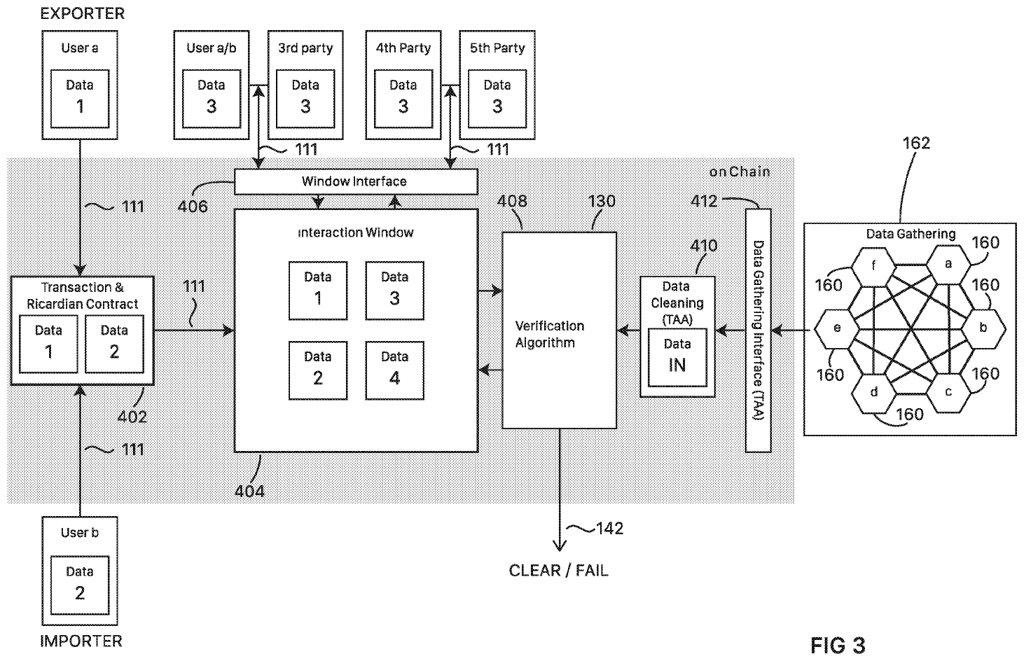

FIG. 3 illustrates another example of the system 300 and security system 100. It includes an example of a security system 100, for example, as described with reference to FIGS. 1 and/or 2.

The system 300 is configured to generate a security alert 142 if a deviation is detected between a measured state 150 of the cargo 10 and the expected state 152 of the cargo 10 at the waypoint 30.

In some but not necessarily all examples, the system 300 is configured to generate a security alert 142 if a deviation is detected between a measured state 150 of the cargo 10 (while the cargo is in-motion) and the expected state 152 of the cargo 10 at the waypoint 30. In this instance, some or all of the measurements made to create the measured state 150 of the cargo are made while the cargo is in motion relative to the sensor (or sensors) 160 performing the measurement.

The Figures illustrate a security system 100 for monitoring cargo 10 during transport 60, comprising means for:
enabling generation 110 of a log 112 for the cargo 10, wherein the log 112 defines one or more expected states 114 of the cargo 10 at one or more waypoints 30 during transport 60;
enabling storage 120 of the log 112 as part of a distributed ledger 200;
enabling a comparison 130 of a measured state of the cargo 10 at a waypoint 30 and an expected state 152 of the cargo 10 at the waypoint 30, wherein the expected state 152 of the cargo 10 at the waypoint 30 is determined by accessing the log 112 within the distributed ledger 200;
generating 140 a security alert 142 if a deviation is detected between the measured state of the cargo 10 and the expected state 152 of the cargo 10 at the waypoint 30.

Referring to FIG. 3, the system 300 comprises: a transaction module 402; interaction module 404; user interface module 406; verification module 408; measurement data processing module 410; and sensor network interface 412.

The interaction module 404 and verification module 408 use the distributed ledger 200 (not shown in FIG. 3).

The code for controlling operation of anyone or more of the modules can also be stored on the digital ledger (or an alternative digital ledger). That is, the modules can be ‘on-chain’.

The transaction module 402 is used to create information for inclusion in the log 112 for the cargo 10.

A user a, for example an exporter, provides data 1 to the transaction module 402. The data comprises cargo properties such as cargo identity (e.g. using Harmonized commodity description and coding system which is an internationally standardized system of names and numbers to classify traded products), cargo size, cargo mass, price, quantity, tariff classification, certificate of origin. The data comprises exporter details such as corporate details, payment and duty requirements, dispatch location, bill of landing, insurance, international trade paperwork etc.

A user b, for example an importer, provides data 2 to the transaction module 402 The data comprises importer details such as corporate details, payment and duty details, delivery location, insurance, international trade paperwork etc

Calculations such as costs and duty are made with options for payment of goods, logistics and duties. Once all data is confirmed as correct and complete, a smart contract is created and upon execution the transaction automatically forwarded to the next stage. A smart contract is a contract that will execute when specified conditions are met. It can be recorded on the distributed ledger 200 or another distributed ledger. If the location data signifies cross-border trade is required, then the transaction is automatically forwarded to the interaction module 404.

The user interface module 406 automatically enables other parties involved in trade and transport to lodge standardised information and documents to fulfil the import, export and transit-related regulatory requirements. This data can include importer, exporter and logistics data as well as banking and insurance data. There may also be data from customs agencies, ministries and permit agencies or other bodies or government agencies. In this example, government agencies (4^{th}, 5^{th} party) and logistics companies (3^{rd} party) create information for inclusion in the log 112 for the cargo 10.

The user interface module 406 can in some but not necessarily all examples provide an application programming interface (API) that sends/receives data to/from additional modules or third party systems.

The logistics company can enter a transportation route and itinerary for the cargo that explicitly or implicitly includes waypoints 30. The itinerary can specify what cargo 10 is dropped-off when and where. The itinerary can specify details of the delivery vehicle 20 such as number plate, mass, image etc. The itinerary can specify details of the driver of the delivery vehicle 20 such as name, passport details, driver licence detail, tachometer card details, facial image, mass etc. The logistics company can also enter customs declarations for pre-border processing.

In some but not necessarily all examples, the interaction module 110 is configured for use in conjunction with additional modules or 3rd party systems for freight services such as, Instant Cargo to Ship Matching, Open and Closed Freight Tendering, Reverse Auctioning.

The government agencies can enter information concerning permits, licences etc. The government agency can make a risk assessment based at least in part on data entered.

The interaction module 110 is configured to receive data from the transaction module 402 and the user interface module 406 to generate a log 112 for the cargo 10. The log 112 defines explicitly or implicitly one or more expected states 114 of the cargo 10 at one or more waypoints 30 during transport 60. For example, an initial mass specified by the importer for a product should remain the mass of the product as cargo 10 until the product is dropped-off. There should not be an abrupt change in mass other than at a drop-off. An abrupt change in mass other than at a drop-off can be detected by the security system 100 as a discrepancy. The total mass of the vehicle in transit should be the mass of the vehicle plus the mass of the driver plus the mass of all cargo (varies with drop-offs) and the mass of fuel (varies with time/distance).

The interaction module 110 is configured to enable storage 120 of the log 112 as part of a distributed ledger 200.

Secure multiparty computation can be used to safeguard private information but at the same time allow data sharing that can be read/written by multiple parties at different times.

The verification module 408 is configured to enable a comparison of a measured state of the cargo 10 at a waypoint 30 and an expected state 152 of the cargo 10 at the waypoint 30, wherein the expected state 152 of the cargo 10 at the waypoint 30 is determined by accessing the log 112 within the distributed ledger 200.

The verification module 408 is configured to enable generation of a security alert 142 if a deviation is detected between the measured state of the cargo 10 and the expected state 152 of the cargo 10 at the waypoint 30.

The deviation can be a deviation in a property of the physical cargo 10 or can be a deviation in a state associated with the cargo's transport.

Examples of deviations may be, for example:

there is a discrepancy between an expected property (e.g. identity . . . ) of a driver and a measured property of a driver; and/or

there is a discrepancy between an expected property (e.g. mass, or identity, signage . . . ) of a vehicle and a measured property of a vehicle; and/or

there is a discrepancy between an expected property (e.g. mass, size, shape, labelling, identity, integrity, solidity, density, composition, or volatile compound signature . . . ) of a cargo and a measured property of a cargo; and/or

there is a discrepancy between an expected property (e.g. open/un-opened door, or heat map . . . ) of a cargo hold/container and a measured property of a cargo hold/container.

The alert 142 can be generated using a suitable push method.

The sensor network interface 412 provides the measurement state from the network 162 of sensors 160. The measurement data processing module 410, if present, performs pre-processing of the measurement state before the comparison performed by the verification module 408.

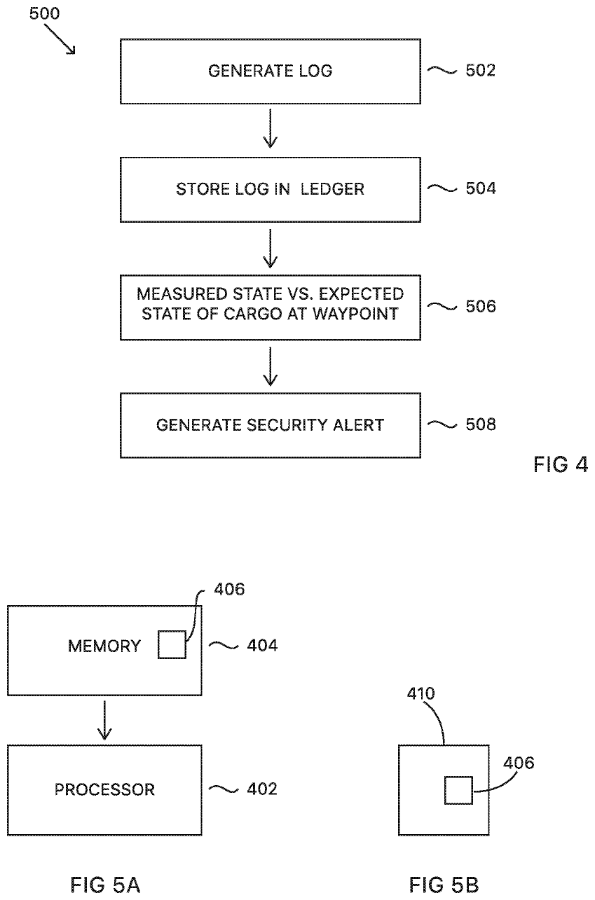

FIG. 4 illustrates an example of a method 500 comprising:

at block 502, enabling generation of a log 112 for the cargo 10, wherein the log 112 defines one or more expected states 114 of the cargo 10 at one or more waypoints 30 during transport 60;

at block 504, enabling storage 120 of the log 112 as part of a distributed ledger 200;

at block 506, enabling a comparison 130 of a measured state of the cargo 10 at a waypoint 30 and an expected state 152 of the cargo 10 at the waypoint 30, wherein the expected state 152 of the cargo 10 at the waypoint 30 is determined by accessing the log 112 within the distributed ledger 200; at block 508, generating 140 a security alert 142 if a deviation is detected between the measured state of the cargo 10 and the expected state 152 of the cargo 10 at the waypoint 30.

The various method and examples described above with reference to FIGS. 1 to 3 are also example usable in the method 500.

FIG. 5A illustrates an example of a controller 400. Implementation of a controller 400 may be as controller circuitry. The controller 400 may be implemented in hardware alone, have certain aspects in software including firmware alone or can be a combination of hardware and software (including firmware).

As illustrated in FIG. 5A the controller 400 may be implemented using instructions that enable hardware functionality, for example, by using executable instructions of a computer program 406 in a general-purpose or special-purpose processor 402 that may be stored on a computer readable storage medium (disk, memory etc) to be executed by such a processor 402.

The processor 402 is configured to read from and write to the memory 404. The processor 402 may also comprise an output interface via which data and/or commands are output by the processor 402 and an input interface via which data and/or commands are input to the processor 402.

The memory 404 stores a computer program 406 comprising computer program instructions (computer program code) that controls the operation of the apparatus 100 when loaded into the processor 402. The computer program instructions, of the computer program 406, provide the logic and routines that enables the apparatus to perform the methods illustrated in FIGS. 1 to 4. The processor 402 by reading the memory 404 is able to load and execute the computer program 406.

The apparatus 100 therefore comprises:

at least one processor 402; and

at least one memory 404 including computer program code

the at least one memory 404 and the computer program code configured to, with the at least one processor 402, cause the apparatus 100 at least to perform:
enabling generation 110 of a log 112 for the cargo 10, wherein the log 112 defines one or more expected states 114 of the cargo 10 at one or more waypoints 30 during transport 60;
enabling storage 120 of the log 112 as part of a distributed ledger 200;
enabling a comparison 130 of a measured state of the cargo 10 at a waypoint 30 and an expected state 152 of the cargo 10 at the waypoint 30, wherein the expected state 152 of the cargo 10 at the waypoint 30 is determined by accessing the log 112 within the distributed ledger 200;
generating 140 a security alert 142 if a deviation is detected between the measured state of the cargo 10 and the expected state 152 of the cargo 10 at the waypoint 30.

As illustrated in FIG. 5B, the computer program 406 may arrive at the apparatus 100 via any suitable delivery mechanism 410. The delivery mechanism 410 may be, for example, data from a distributed ledger, a machine readable medium, a computer-readable medium, a non-transitory computer-readable storage medium, a computer program product, a memory device, a record medium such as a Compact Disc Read-Only Memory (CD-ROM) or a Digital Versatile Disc (DVD) or a solid state memory, an article of manufacture that comprises or tangibly embodies the computer program 406. The delivery mechanism may be a signal configured to reliably transfer the computer program 406. The apparatus 100 may propagate or transmit the computer program 406 as a computer data signal.

Computer program instructions for causing an apparatus to perform at least the following or for performing at least the following:
causing generation of a log 112 for the cargo 10, wherein the log 112 defines one or more expected states 114 of the cargo 10 at one or more waypoints 30 during transport 60;
causing storage of the log 112 as part of a distributed ledger 200;
causing a comparison of a measured state of the cargo 10 at a waypoint 30 and an expected state 152 of the cargo 10 at the waypoint 30, wherein the expected state 152 of the cargo 10 at the waypoint 30 is determined by accessing the log 112 within the distributed ledger 200;
causing generation of a security alert 142 if a deviation is detected between the measured state of the cargo 10 and the expected state 152 of the cargo 10 at the waypoint 30.

The computer program instructions may be comprised in a computer program, a non-transitory computer readable medium, a computer program product, a machine readable medium. In some but not necessarily all examples, the computer program instructions may be distributed over more than one computer program.

Although the memory 404 is illustrated as a single component/circuitry it may be implemented as one or more separate components/circuitry some or all of which may be integrated/removable and/or may provide permanent/semi-permanent/dynamic/cached storage.

Although the processor 402 is illustrated as a single component/circuitry it may be implemented as one or more separate components/circuitry some or all of which may be integrated/removable. The processor 402 may be a single core or multi-core processor.

References to ‘computer-readable storage medium’, ‘computer program product’, ‘tangibly embodied computer program’ etc. or a ‘controller’, ‘computer’, ‘processor’, ‘logic’ etc. should be understood to encompass not only computers having different architectures such as single/multi-processor architectures and sequential (Von Neumann)/parallel architectures but also specialized circuits such as field-programmable gate arrays (FPGA), application specific circuits (ASIC), signal processing devices and other processing circuitry. References to computer program, instructions, code etc. should be understood to encompass software for a programmable processor or firmware such as, for example, the programmable content of a hardware device whether instructions for a processor, or configuration settings for a fixed-function device, gate array or programmable logic device etc.

The blocks/modules illustrated in the FIGS. 2 to 4 may represent steps in a method and/or sections of code in the computer program 406. The illustration of a particular order to the blocks does not necessarily imply that there is a required or preferred order for the blocks and the order and arrangement of the block may be varied. Furthermore, it may be possible for some blocks to be omitted.

Where a structural feature has been described, it may be replaced by means for performing one or more of the functions of the structural feature whether that function or those functions are explicitly or implicitly described.

In some but not necessarily all examples, the security system 100 is used for in package logistics and complex production lines such as in car manufacture.

In some but not necessarily all examples, the security system 100 is used for parcel sorting and logistics where the volume, mass, and other details of the parcels are captured to enable automated categorization and sorting.

In some but not necessarily all examples, the security system 100 is used in a production line to check all items are as expected and conform to the rules of origin requirements for trade.

In some but not necessarily all examples a single waypoint is used in a gateway configuration (similar to airport baggage check).

In some but not necessarily all examples, data is processed at the sensors 160 rather than centrally.

In some but not necessarily all examples, the sensors 160 are arranged in multiple layouts such as centralized, distributed, decentralized or a combination of these. In some but not necessarily all examples, some or all of the steps in methods that can be performed automatically are performed automatically.

In some but not necessarily all examples, the methods and systems are autonomous.

In some but not necessarily all examples, the apparatus 100 is configured to communicate data from the apparatus 100 with or without local storage of the data in a memory 404 at the apparatus 100 and with or without local processing of the data by circuitry or processors at the apparatus 100.

The data may be stored in processed or unprocessed format remotely at one or more devices. The data may be stored in the Cloud.

The data may be processed remotely at one or more devices. The data may be partially processed locally and partially processed remotely at one or more devices.

The data may be communicated to the remote devices wirelessly via short range radio communications such as Wi-Fi or Bluetooth, for example, or over long range cellular radio links. The apparatus may comprise a communications interface such as, for example, a radio transceiver for communication of data.

The apparatus 100 may be part of the Internet of Things forming part of a larger, distributed network.

The systems, apparatus, methods and computer programs may use machine learning which can include statistical learning. Machine learning is a field of computer science that gives computers the ability to learn without being explicitly programmed.

The computer learns from experience E with respect to some class of tasks T and performance measure P if its performance at tasks in T, as measured by P, improves with experience E. The computer can often learn from prior training data to make predictions on future data. Machine learning includes wholly or partially supervised learning and wholly or partially unsupervised learning. It may enable discrete outputs (for example classification, clustering) and continuous outputs (for example regression). Machine learning may for example be implemented using different approaches such as cost function minimization, artificial neural networks, support vector machines and Bayesian networks for example. Cost function minimization may, for example, be used in linear and polynomial regression and K-means clustering. Artificial neural networks, for example with one or more hidden layers, model complex relationship between input vectors and output vectors. Support vector machines may be used for supervised learning. A Bayesian network is a directed acyclic graph that represents the conditional independence of a number of random variables.

The term ‘comprise’ is used in this document with an inclusive not an exclusive meaning. That is any reference to X comprising Y indicates that X may comprise only one Y or may comprise more than one Y. If it is intended to use ‘comprise’ with an exclusive meaning then it will be made clear in the context by referring to “comprising only one . . . ” or by using “consisting”.

In this description, reference has been made to various examples. The description of features or functions in relation to an example indicates that those features or functions are present in that example. The use of the term ‘example’ or ‘for example’ or ‘can’ or ‘may’ in the text denotes, whether explicitly stated or not, that such features or functions are present in at least the described example, whether described as an example or not, and that they can be, but are not necessarily, present in some of or all other examples. Thus ‘example’, ‘for example’, ‘can’ or ‘may’ refers to a particular instance in a class of examples. A property of the instance can be a property of only that instance or a property of the class or a property of a sub-class of the class that includes some but not all of the instances in the class. It is therefore implicitly disclosed that a feature described with reference to one example but not with reference to another example, can where possible be used in that other example as part of a working combination but does not necessarily have to be used in that other example.

Although embodiments have been described in the preceding paragraphs with reference to various examples, it should be appreciated that modifications to the examples given can be made without departing from the scope of the claims.

Features described in the preceding description may be used in combinations other than the combinations explicitly described above.

Although functions have been described with reference to certain features, those functions may be performable by other features whether described or not.

Although features have been described with reference to certain embodiments, those features may also be present in other embodiments whether described or not.

Although certain examples or details have been described with reference to certain embodiments, those examples or details are also included by this reference in other embodiments.

The term ‘a’ or ‘the’ is used in this document with an inclusive not an exclusive meaning. That is any reference to X comprising a/the Y indicates that X may comprise only one Y or may comprise more than one Y unless the context clearly indicates the contrary. If it is intended to use ‘a’ or ‘the’ with an exclusive meaning then it will be made clear in the context. In some circumstances the use of ‘at least one’ or ‘one or more’ may be used to emphasis an inclusive meaning but the absence of these terms should not be taken to infer and exclusive meaning.

The presence of a feature (or combination of features) in a claim is a reference to that feature or (combination of features) itself and also to features that achieve substantially the same technical effect (equivalent features). The equivalent features include, for example, features that are variants and achieve substantially the same result in substantially the same way. The equivalent features include, for example, features that perform substantially the same function, in substantially the same way to achieve substantially the same result.

In this description, reference has been made to various examples using adjectives or adjectival phrases to describe characteristics of the examples. Such a description of a characteristic in relation to an example indicates that the characteristic is present in some examples exactly as described and is present in other examples substantially as described.

Whilst endeavoring in the foregoing specification to draw attention to those features believed to be of importance it should be understood that the Applicant may seek protection via the claims in respect of any patentable feature or combination of features hereinbefore referred to and/or shown in the drawings whether or not emphasis has been placed thereon.

I/we claim:

1. A security system for monitoring cargo in motion during transport, comprising:
at least one processor; and
at least one memory including computer program code;
the at least one memory and the computer program code configured to, with the at least one processor, cause the apparatus at least to perform:
enabling generation of a log for the cargo, wherein the log defines one or more expected states of the cargo at one or more waypoints during transport, wherein an expected state is dependent upon at least a mass or volume of the cargo;
enabling storage of the log as part of a distributed ledger;
enabling a comparison of a measured state of the cargo at a waypoint, while in motion, and an expected state of the cargo at the waypoint, wherein the measured state of the cargo at the waypoint is dependent upon at least a measured mass or volume of the cargo, wherein the expected state of the cargo at the waypoint is determined by accessing the log within the distributed ledger;
generating a security alert if a deviation is detected between the measured state of the cargo and the expected state of the cargo at the waypoint.

2. A security system as claimed in claim 1, wherein the comparison of the measured state of the cargo at the waypoint and the expected state of the cargo at the waypoint is performed using machine-learning.

3. A security system as claimed in claim 1, wherein the comparison accounts for at least one of:
an effect of motion on measurement of the measured state of the cargo at a waypoint, while in motion or
an effect of fuel consumption on the measured state of the cargo at a waypoint, while in motion.

4. (canceled)

5. A security system as claimed in claim 1, wherein the comparison comprises forming a collective measured state of the cargo at the waypoint from multiple measured states at multiple waypoints while in motion including the measured state of the cargo at the waypoint, while in motion,
enabling a comparison of the collective measured state of the cargo at the waypoint and the expected state of the cargo at the waypoint.

6. A security system as claimed in claim 5, wherein the collective measured state is formed from multiple measured states at multiple waypoints by one or more of the following singly or in combination:
competitive selection of measured states;
complementary addition of measured states; and
cooperative combination of measured states.

7. A security system as claimed in claim 5, wherein the collective measured state is formed from multiple measured states by averaging all or a sub-set of the measured states.

8. A security system as claimed in claim 1, wherein the log for the cargo is generated in response to input information from an importer of the cargo and/or an exporter of the cargo and wherein the input information comprises a digital signature of the importer and a digital signature of the exporter and wherein the digital signature is created using public/private key encryption.

9-10. (canceled)

11. A security system as claimed in claim 1, wherein the log comprises properties of the cargo including the mass and/or volume of the cargo and information relating to transport of the cargo including expected itinerary.

12. A security system as claimed in claim 1, wherein the at least one memory and the computer program code are configured to, with the at least one processor, cause the apparatus to perform:
causing the log within the distributed ledger to be updated with at least an entry comprising the measured state of the cargo at the waypoint, while in motion.

13. A security system as claimed in claim 1, wherein each of the multiple expected states of the cargo defines properties of the cargo including the mass and/or volume of the cargo that are expected at a given stage during transport.

14. A security system as claimed in claim 1, wherein storing the log as part of a distributed ledger comprises storing the log as data within a block of a blockchain or as data within a blockless distributed ledger.

15. (canceled)

16. A security system as claimed in claim 1, wherein the at least one memory and the computer program code are configured to, with the at least one processor, cause the apparatus to perform;
receiving at least one measured state of the cargo, at the waypoint, while in motion during transport, the measured state comprising at least one or more sensed properties of the cargo in addition to or including mass or volume of the cargo.

17. A security system as claimed in claim 1, wherein the at least one memory and the computer program code are configured to, with the at least one processor, cause the apparatus to perform;
receiving a detected unique identifier associated with the cargo that has been detected at the waypoint while in motion during transport of the cargo, using the received unique identifier to enable identification of the log for the cargo within the distributed ledger, wherein the identification of the log within the distributed ledger enables the comparison of the measured state of the cargo at the waypoint and the expected state of the cargo at the waypoint.

18. A security system as claimed in claim 17, wherein the unique identifier associated with the cargo comprises one or more of: a unique identifier of a vehicle transporting the cargo, a unique identifier of a driver of a vehicle transporting the cargo, and a unique identifier of the cargo.

19. A security system as claimed in claim 1, wherein generating a security alert comprises sending a signed data structure via a telecommunications network to a remote customs monitoring station.

20. A security system as claimed in claim 1, wherein the at least one memory and the computer program code are configured to, with the at least one processor, cause the apparatus to perform;
enabling generation of a log for the cargo, wherein the log defines one or more expected states of the cargo at one or more waypoints during transport, wherein an expected state is dependent upon at least a mass of the cargo and/or a volume of the cargo.

21. A system comprising a security system as claimed in claim 1 and a distributed network of sensors configured to measure states of the cargo at waypoints, while in motion.

22. A borderless customs arrangement comprising a system as claimed in claim 1 wherein the sensors are not located at the border.

23. (canceled)

24. A method of performing custom checks on vehicles during transport, comprising
enabling generation of a log for the cargo, wherein the log defines one or more expected states of the cargo at one or more waypoints during transport, wherein an expected state is dependent upon at least a mass or volume of the cargo;
enabling storage of the log as part of a distributed ledger;
enabling a comparison of a measured state of the cargo at a waypoint, while in motion, and an expected state of the cargo at the waypoint, wherein the measured state of the cargo at the waypoint dependent upon at least a measured mass or volume of the cargo, wherein the expected state of the cargo at the waypoint is determined by accessing the log within the distributed ledger;
generating a customs security alert if a deviation is detected between the measured state of the cargo and the expected state of the cargo at the waypoint.

25. A security system for monitoring cargo during transport, comprising:
at least one processor; and
at least one memory including computer program code;
the at least one memory and the computer program code configured to, with the at least one processor, cause the apparatus at least to perform:
enabling generation of a log for the cargo, wherein the log defines one or more expected states of the cargo at one or more waypoints during transport;
enabling storage of the log as part of a distributed ledger;
enabling a comparison of a measured state of the cargo at a waypoint and an expected state of the cargo at the waypoint,
wherein logic for enabling the comparison is determined by accessing the log within the distributed ledger;
wherein the expected state of the cargo at the waypoint is determined by accessing the log within the distributed ledger; and
generating a security alert if a deviation is detected between the measured state of the cargo and the expected state of the cargo at the waypoint.
